(19) United States
(12) Patent Application Publication
(10) Pub. No.: US 2005/0129493 A1
(43) Pub. Date: Jun. 16, 2005

(54) Load-carrying apparatus

(76) Inventor: Fabien Lavoie, Grand-Mere (CA)

Correspondence Address: OGILVY RENAULT, 1981 MCGILL COLLEGE AVENUE, SUITE 1600, MONTREAL, QC, H3A2Y3, CA

(21) Appl. No.: 10/731,110

(22) Filed: Dec. 10, 2003

(51) Int. Cl. B60P 1/00

(52) U.S. Cl. 414/529

(57) ABSTRACT

An apparatus for carrying loads on inclined surfaces, comprising a support surface adapted to fixedly support a load. An endless track is connected to the support surface and adapted to propel the apparatus on an inclined surface. A power source is provided for actuating the endless track. An anti-roll device is provided for increasing a length of the apparatus beyond the endless track in a direction of movement of the apparatus on the inclined surface to prevent an overturning of the apparatus when transporting loads.

### BACKGROUND OF THE INVENTION

1. Field of the Invention

The present invention generally relates to load-carrying apparatuses and, more specifically, to load-carrying apparatuses used to transport heavy goods on limited-access inclined surfaces, such as staircases.

2. Background Art

Various types of load-carrying apparatuses have been developed to carry loads up or down inclined surfaces, that are not readily accessible by larger vehicles such as trucks. For instance, such load-carrying apparatuses are used inside buildings without elevators, or in which elevators cannot accommodate the loads to be carried up. Such apparatuses are used when loads are beyond size and/or weight ranges of human carriers.

A simple form of a load-carrying apparatus has an endless belt, or track, providing the traction, and a support surface to secure the load to the apparatus. A potential problem with such load-carrying apparatuses occurs when loads of a normegligible height are carried over the inclined surfaces. The center of inertia of the loads is generally related to the height with respect to the ground. Accordingly, loads of normegligible height increase the height of the center of inertia with respect to the inclined surface. As a function of the inclination surface, the gravity can cause the overturning of the load and the load-carrying apparatus. The overturning of the load will not only damage the load, but will also represent a potential danger to people in the surrounding area of the load.

### SUMMARY OF INVENTION

It is therefore an aim of the present invention to provide a novel load-carrying apparatus.

It is a further aim of the present invention to provide a load-carrying apparatus having a mechanism to reduce the risk of overturning.

It is a still further aim of the present invention to provide a load-carrying apparatus having mechanisms for facilitating the positioning of loads thereon.

Therefore, in accordance with the present invention, there is provided an apparatus for carrying loads on inclined surfaces, comprising: a support surface adapted to fixedly support a load; an endless track connected to the support surface and adapted to propel the apparatus on an inclined surface; a power source for actuating the endless track; and an anti-roll device for increasing a length of the apparatus beyond the endless track in a direction of movement of the apparatus on the inclined surface to prevent an overturning of the apparatus when transporting loads.

Further in accordance with the present invention, there is provided an apparatus for carrying loads on inclined surfaces, comprising: a support surface adapted to fixedly support a load; an endless track connected to the support surface and adapted to propel the apparatus on an inclined surface; a power source for actuating the endless track; and a cylindrical roller mounted to the apparatus adjacent to the support surface, for facilitating the positioning of a load onto the support surface.

### BRIEF DESCRIPTION OF THE DRAWINGS

Having thus generally described the nature of the invention, reference will now be made to the accompanying drawings, showing by way of illustration a preferred embodiment thereof and in which:

FIG. 1 is a perspective view of a load-carrying apparatus in accordance with a preferred embodiment of the present invention, with an endless track removed;

FIG. 2 is a perspective view of the load-carrying apparatus of FIG. 1, with a portion of casing and rollers removed;

FIG. 3 is a perspective view of the load-carrying apparatus of FIG. 2, from a rear point of view;

FIG. 4 is a side elevation view of the load-carrying apparatus;

FIG. 5 is a side elevation view of the load-carrying apparatus in accordance with a further embodiment of the present invention;

FIG. 6 is a side elevation view of the load-carrying apparatus in accordance with a still further embodiment of the present invention

FIG. 7 is a side elevation view of an endless track for the load-carrying apparatus of the present invention; and

FIG. 8 is a perspective view of a roller device for the load-carrying apparatus of the present invention.

### DESCRIPTION OF THE PREFERRED EMBODIMENTS

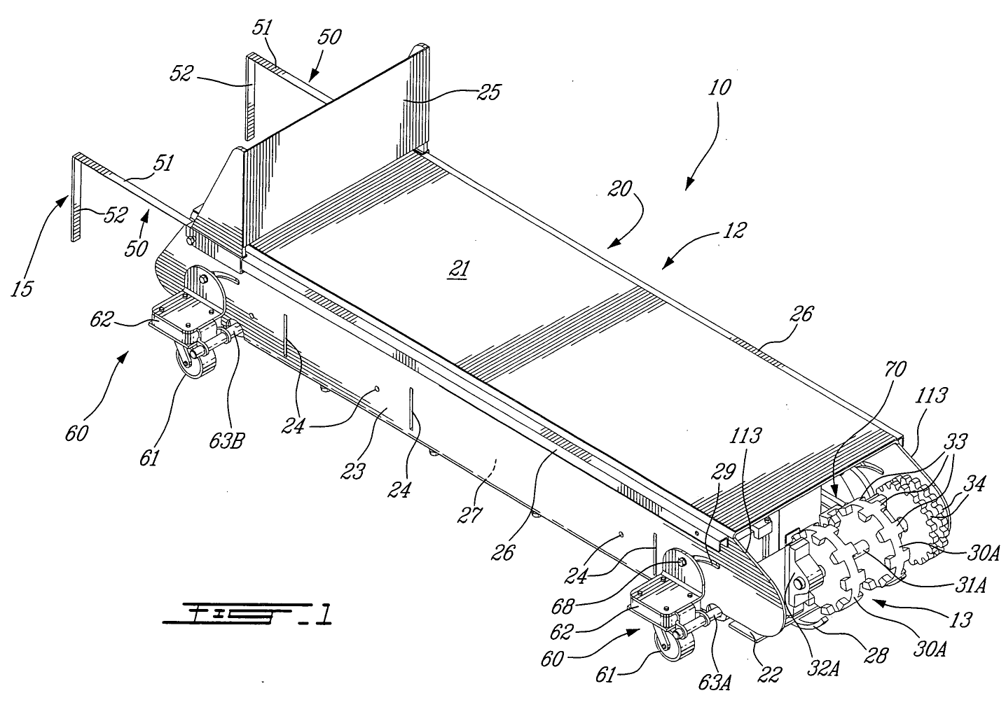

Referring to the drawings, and more particularly to FIG. 1, a load-carrying apparatus in accordance with a preferred embodiment of the present invention is generally shown at 10. The apparatus 10 has a body 12 supporting an endless track system 13, a power source 14, and an anti-roll device 15. Each of these elements will be described in further detail hereinafter.

The Body 12

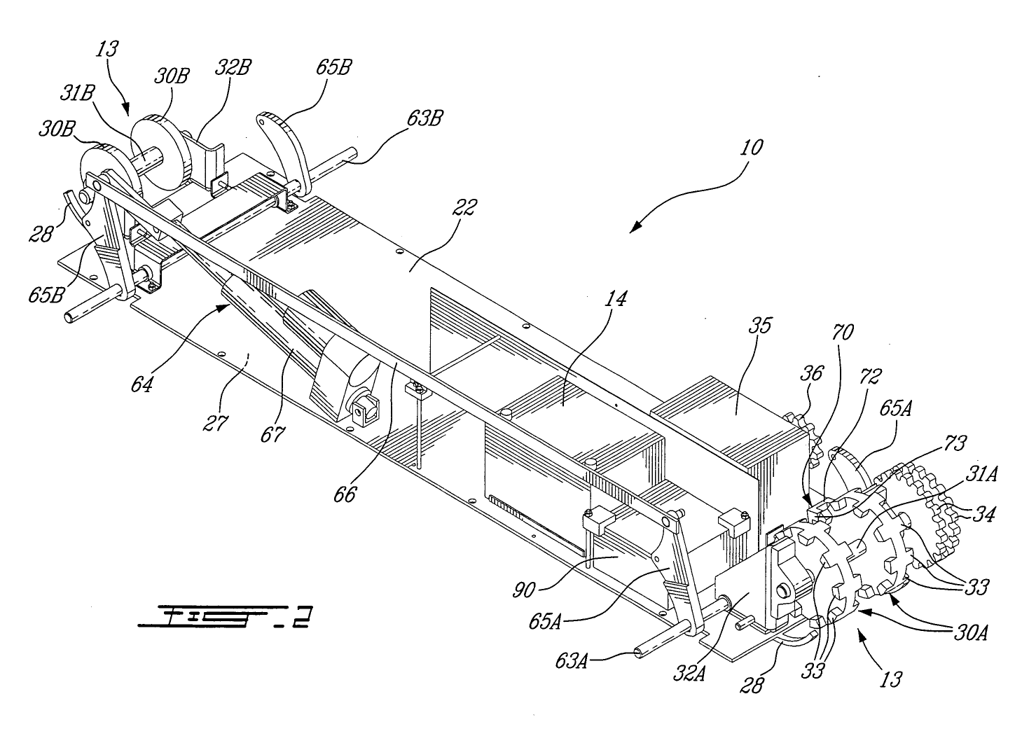

Referring concurrently to FIGS. 1 and 2, the body 12 defines the structure of the apparatus 10 and supports the various elements of the apparatus 10. More specifically, the body 12 has an elongated rectangular cross-section hollow casing 20, having an upper plate defining a load-supporting surface 21 and a lower plate defining an element-supporting surface 22. The upper plate and the lower plate are spaced from one another so as to define an inner cavity of the casing 20, in which various elements of the apparatus 10 will be held. A pair of lateral sides 23 are integrally formed with the upper plate (e.g., a single sheet), and lower plate, as best seen in FIG. 2, is fixed to the lateral sides 23 to define therewith the hollow casing 20 (FIG. 1).

The load-supporting surface 21 and lateral side 23 of the casing 20 are equipped with various connectors in view of the securement of a load on the load-supporting surface 21. For instance, various slots and holes 24 are illustrated in the lateral side 23 exposed in FIG. 1 so as to accommodate straps and other similar securement means. Moreover, the upper plate is preferably reinforced (e.g., with transverse beams) so as to sustain the load secured to the load-supporting surface 21.

Referring to FIG. 1, a back system is optionally provided in order to offer additional support to a load being carried on the load-supporting surface 21. The system has a back plate 25 that is supported so as to be translatable with respect to a longitudinal direction of the apparatus 10. More specifically, rails 26 are respectively positioned on the lateral sides 23 to enable the translating motion of the back plate 25 with respect to the casing 20. Releasable fasteners are used in order to secure the back plate 25 in a given position with respect to the casing 20. It is pointed out that the releasable fastener provides fastening of sufficient magnitude in order to withstand a portion of the load carried by the apparatus 10 when the apparatus 10 is on an inclined surface. Also, it is contemplated to provide the load-supporting surface 21 with a rubbery surface or the like, to increase the adherence of a load onto the load-supporting surface 21.

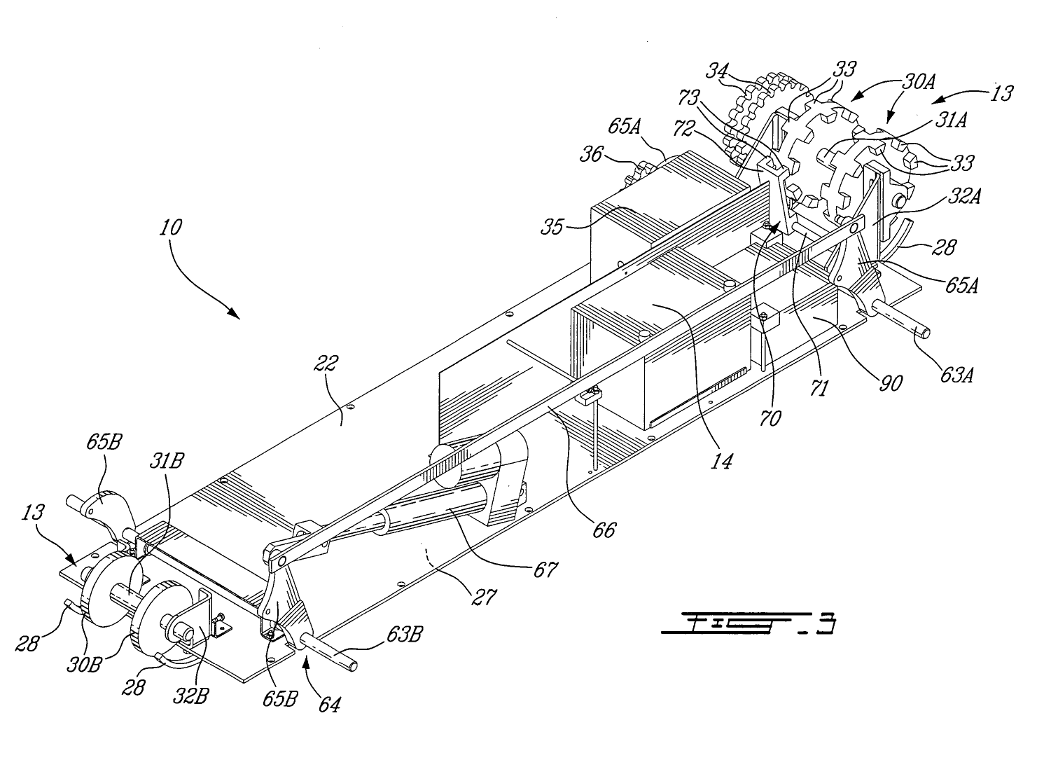

Referring to FIGS. 2 and 3, the lower plate has an undersurface 27 upon which an endless track of the apparatus 10 will slide to provide the apparatus 10 with traction. The undersurface 27 will ensure that the endless track remains in contact against the inclined surface. The undersurface 27 is optionally lubricated or provided with a low-adherence coating.

A pair of guide bars 28 are provided on the full length of the undersurface 27, so as to define a channel therebetween. The guide bars 28 will therefore enclose the endless track such that the latter remains centered in the apparatus 10. The guide bars 28 project beyond the undersurface 27 with curled ends to guide the endless track off/onto the undersurface 27.

The Endless Track System 13

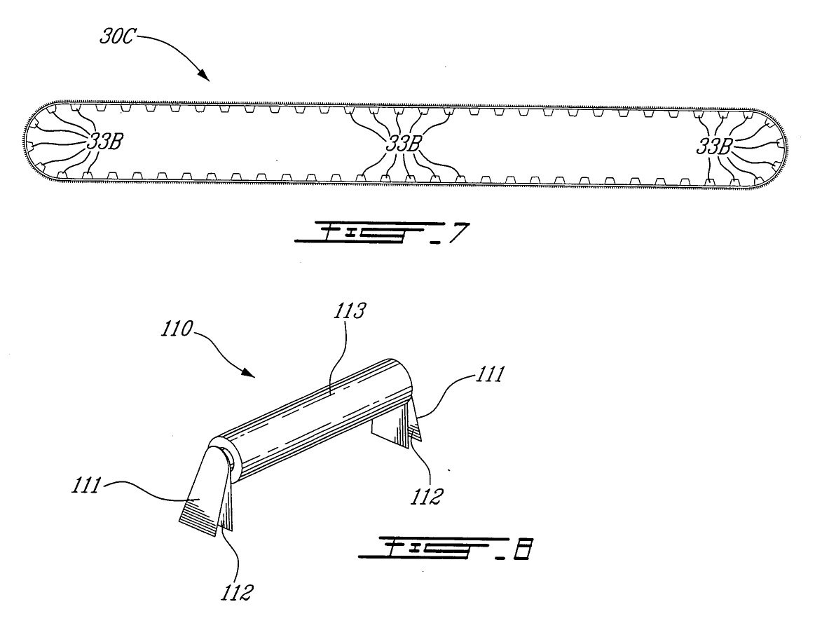

Referring concurrently to FIGS. 1, 2 and 3, the endless track system 13 has pairs of front wheels 30A and back wheels 30B to actuate the endless track. The front wheels 30A are the drive wheels, whereas the back wheels 30B are driven by the endless track, the latter being shown separately as 30C in FIG. 7. The pairs of wheels 30A and 30B are respectively interconnected by shafts 31A and 31B. The shafts 31A and 31B are mounted to the element-supporting surface 22 by brackets 32A and 32B, respectively. Longitudinal fingers 33 are provided to engage with complementary fingers 33B within the endless track 30C (FIG. 7). The fingers 33B of the endless track 30C (FIG. 7) are received between the longitudinal fingers 33 of the front wheels 30A, whereby the endless track 30C (FIG. 7) is driven by the front wheels 30A.

A pair of driven sprockets 34 are provided at an end of the shaft 31A so as to receive a drive from a drive source 35 of the endless track system 13. In a preferred embodiment of the present invention, the drive source 35 is an electric motor equipped with a reducer in order to provide a suitable amount of torque to the front wheels 30A. As best seen in FIGS. 2 and 3, a drive sprocket 36 of the drive source 35 is positioned adjacent to the driven sprockets 34. A chain is used to transmit motion from the drive sprocket 36 to the driven sprocket 34 of the shaft 31A. Gears, pulleys and belt and the like could alternatively be used to transmit motion from the drive source 35 to the front wheels 30A.

Referring concurrently to FIGS. 1, 2 and 3, the guide bars 28 are positioned so as to guide the endless track 30C (FIG. 7) from the front wheels 30A to the undersurface 27, and from the undersurface 27 to the back wheels 30B. The casing 20 defines a clearance just below the load-supporting surface 21, through which the endless track 30C (FIG. 7) will pass. It is pointed out that the brackets 32 and/or the wheels 30A and 30B are suitably provided with bearings in order to ensure the efficient rotation of the wheels 30B and 30B in the apparatus 10.

The endless track is typically made of a polymeric material, and may be provided with treads or like surfacing to ensure suitable traction of the apparatus 10. Moreover, it is contemplated to provide the endless track with spikes for icy conditions. Moreover, although the apparatus 10 is illustrated as having a single endless track 30 (FIG. 7), it is contemplated to provide the apparatus 10 with a pair of tracks. In an embodiment with a pair of tracks, the drive to the endless tracks has two degrees of actuation and independent drive mechanisms, whereby the tracks may be actuated in opposite directions with respect to one another, to allow the apparatus 10 to rotate. Alternatively, the apparatus 10 may be provided with a peripheral rotating table, so as to rotate the apparatus 10.

The Power Source 14

Referring to FIGS. 2 and 3, the power source 14 is illustrated being positioned adjacent to the drive source 35. More specifically, the power source 14 is a battery that will operate the drive source 35. Moreover, as will be described hereinafter, the apparatus 10 has other electrically devices that are to be powered by the power source 14. The drive source 35 is therefore an electric motor that can be readily actuated for forward or reverse motion.

The Anti-Roll Device 15

Referring to FIGS. 1 and 4, the anti-roll device is generally shown at 15. The anti-roll device 15 has a pair of arms 50 that project rearwardly from the apparatus 10. According to a preferred embodiment of the present invention, the arms 50 each have a longitudinal portion 51 generally parallel to a longitudinal axis of the apparatus 10, and a downwardly-facing end projection 52, generally perpendicular to the longitudinal portion 51.

The arms 50 come into contact with the inclined surface in the event that the apparatus 10, and its load, tend to overturn. As seen in FIG. 4, the end projections 52 are slightly above the undersurface 27, so as not to impede with the normal displacement of the apparatus 10, but to come into contact with the inclined surface upon which is the apparatus 10, as soon as there is motion of the apparatus 10 toward overturning.

Therefore, the arms 50 increase the length of the apparatus 10 so as to prevent an overturning of the apparatus 10. Considering that the tendency to overturn is related to the position of center of inertia of the load/apparatus 10 combination, the length of the arm 50 may be decided according to the type of loads that the apparatus 10 is expected to carry. Moreover, although an L-shape is described for the arms 50, other suitable shapes could be provided. For instance, the end projection 52 lose their efficiency in stair cases between nosings of stairs. Accordingly, it is contemplated to provide another projection that is parallel to the longitudinal portions 51, and slightly above the undersurface 27 when the apparatus 10 is horizontal.

It is also contemplated to have the arms 50 release automatically from a tucked position under the upper plate. More specifically, a mercury level trigger, such as that described in U.S. Pat. No. 5,996,767, issued to Misawa on Dec. 7, 1999, could be used in conjunction with the power source 14 to actuate the release of the arms 50 from the tucked position. The mercury level trigger could be adjusted to release the arms 50 for a predetermined incline of the apparatus 10.

The automatic release of the arms 50 is preferred in instances where the variation in incline is abrupt. For instance, if the apparatus 10 goes from a horizontal surface to an inclined surface, the arms 50 could impede on the displacement of the apparatus 10. Therefore, rather than having the hazardous situation in which a person goes behind the loaded apparatus 10 to release the arms 50 after the apparatus 10 has reached the inclined surface, the arms 50 would release automatically upon reaching the inclined surface. Alternatively, the releasing of the arms 50 of the anti-roll device 15 could be performed by a remote controller. As the power source 14 is preferably electrical, linear actuators (as shown at 51 in FIG. 4) or valves can be used to release the arms 50.

Roller System 60

Referring to FIG. 1, the apparatus 10 is optionally provided with a secondary roller system 60. The roller system 60 has rollers 61 positioned at the four corners of the apparatus 10, and are releasable from a retracted position to be used instead of the endless track system 13. For instance, the roller system 60 is used when the apparatus 10 is on a flat surface, when traction is not required, and when the loaded apparatus 10 can be pushed around manually.

The rollers 61 are of the swivel type to facilitate the guiding of the loaded apparatus 10. Therefore, the rollers 61 each have a swivel mount 62. As seen in FIG. 1, the swivel mounts 62 (two of which are visible) are respectively mounted to a front pivot bar 63A and a rear pivot bar 63B. The lateral sides 23 of the casing 20 have arcuate guideways 29, and the swivel mounts 62 each have a guide pin within a respective guideway 29, so as to be guided between the retracted position and a deployed position, which is shown in FIG. 1.

Referring to FIGS. 2 and 3, a mechanism for actuating a change of position of the rollers 61 is generally shown at 64, with the rollers being removed from FIGS. 2 and 3 for clarity purposes. The front pivot bar 63A and the rear pivot bar 63B are pivotally mounted to the lower plate so as to be rotatable about their longitudinal axes. The mechanism 64 has levers 65A and 65B, respectively mounted to the front pivot bar 63A and the rear pivot bar 63B. A link 66 interconnects the levers 65A and 65B, so as to define a parallel mechanism therewith. An actuator 67 (e.g., a linear actuator, a hydraulic cylinder), is provided to actuate the displacement of the parallel mechanism formed by the levers 65A, 65B and the link 66. The actuator 67 is sized so as to be adapted to deploy the rollers 61 with the apparatus 10 being loaded.

The levers 65A and 65B each receive a guide pin of the swivel mount 62, so as to actuate the displacement of the rollers 61 between the retracted position and the deployed position. One of the guide pins is shown at 68 in FIG. 3.

Locking System 70

Referring to FIGS. 2 and 3, the apparatus 10 is optionally provided with a locking system 70 to lock the endless track system 13. The locking system 70 has a pivot bar 71 and a brake 72. As best seen in FIG. 3, the brake 72 has fingers 73 that will engage with the longitudinal fingers 33 of the front wheels 30A, so as to prevent the rotation of the front wheels 30A, and hence of the endless track thereon.

As an example, the locking system 70 is to be actuated when the loaded apparatus 10, moving upwardly on an inclined surface, moves downwardly due to a power failure from the power source 14. In this example, the brake 72 may be of the ratchet type, to enable a unidirectional rotation of the front wheels 30A.

However, the apparatus 10 will also be used to carry loads down inclined surfaces, whereby another locking system 70 could be used to prevent the unwanted downward acceleration of the loaded apparatus 10.

For instance, the locking system 70 may be manually deployed by a nearby operator through the use of a cable that will release the locking system 70 into engagement with the front wheel 30A. Alternatively, the locking system 70 could be electrically powered and its release could be triggered using a remote controller.

Leveling Table 80

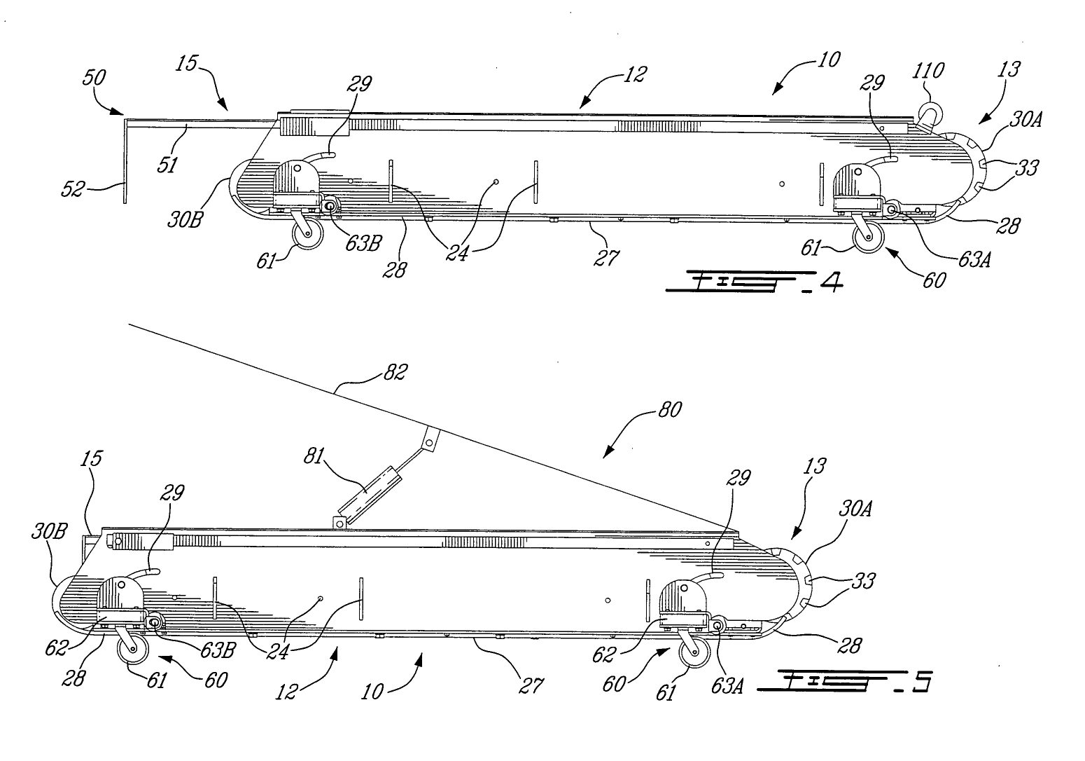

Referring to FIG. 5, a leveling table 80 is optionally provided on the apparatus 10. In instances where loads must be kept horizontal (e.g., a wheel chaired person), the leveling table 80 is used to achieve the leveling. More specifically, an actuator 81 is provided to lift a plate 82 pivotally mounted at a front end to an upper surface of the casing 20. The actuator 81 must be sized to support a load on the plate 82.

Other Features

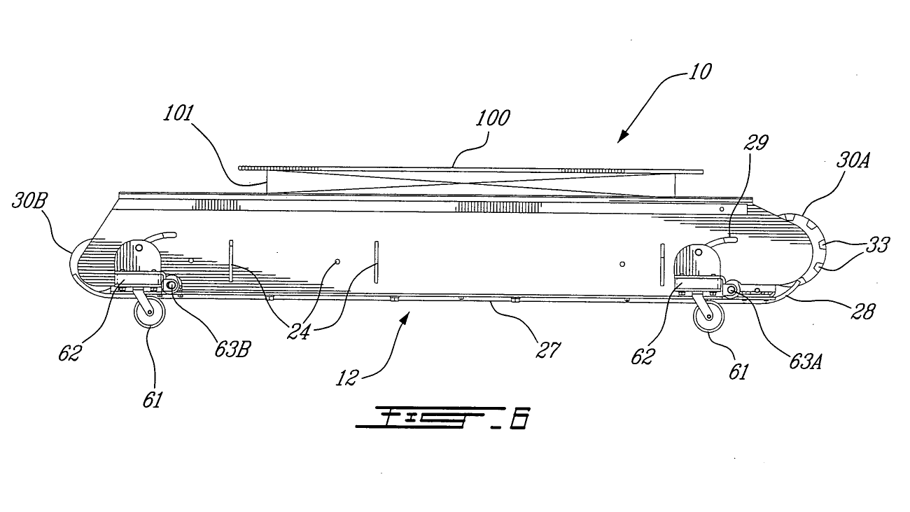

Referring to FIG. 6, there is shown improvements to the present invention, in which the apparatus 10 has a vertically displaceable load-supporting surface 100, by way of a scissor mechanism 101 suitably actuated, (e.g., with the power source 14). This feature is used to facilitate the reception/removal of a load on/from the load-supporting surface 100. For instance, the load may be slid onto the load-supporting surface 100 from a transport vehicle (e.g., track). Alternatively, the load-supporting surface 100 may be lifted to slidingly displace a load onto an elevated surface (e.g., track, loading dock).

Referring to FIGS. 2 and 3, a charger is generally shown at 90, so as to re-charge the power source 14, in embodiments of the present invention in which the power source 14 is a battery. A power generator is optionally provided to recharge the power source 14, to confer a greater autonomy to the apparatus 10.

It has been discussed that the apparatus 10 is preferably remotely controlled. More specifically, a wireless or wired control pad can be related to the drive source 35 so as to control the displacement of the loaded apparatus 10 from a distance. Moreover, the control pad may have other functions, such as the deployment or retracting of the rollers 61 of the roller system 60 (FIGS. 1, 2 and 3), as well as the leveling of the leveling table 80. The use of remote distance control is advantageous in that the apparatus 10 carries heavy loads that could cause serious damage and harm if dropped. Therefore, the operator is to be positioned at a safe distance (e.g., upstairs) from the apparatus 10 when the latter carries loads on inclined surfaces.

As a further suggested feature of the apparatus of the present invention, a buggy (not shown) may be added to the apparatus 10. For instance, such a buggy can be used to further increase the load-carrying surface associated with the apparatus 10. It is pointed out that the buggy is not to impede with the action of the anti-roll device 15.

It has been discussed previously that the apparatus 10 of the present invention may be provided with a mercury level trigger for releasing the arms 50 of the anti-roll device 15. Such a level trigger could also be used to indicate that the inclined surface upon which the apparatus 10 operates is too steep for safe operation, or beyond predetermined inclination values.

Referring to FIG. 8, a conveying roller is generally shown at 110. The conveying roller 110 has a pair of legs 111 each defining a slot 112. The legs 111 support a cylindrical roller 113, such that the cylindrical roller 113 is free to rotate about its longitudinal axis. The conveying roller 110 will be used to facilitate the loading of an item onto the load-supporting surface 21.

More specifically, referring to FIG. 1, the lateral sides 23 of the apparatus 10 are shown having a pair of projecting portions 113 adjacent to a front end of the apparatus 10. As shown in FIG. 4, the conveying roller 110 is positioned onto the apparatus 10 with the projecting portions 113 received in the slots 112 of the legs 111.

In order to load the apparatus 10, an object may be tilted onto the conveying roller 110, at which point the conveying roller 110 is used to help a person push the object into position on the load-supporting surface 21. The conveying roller 110 may also be used to discharge an object from the apparatus 10. The conveying roller 110 is particularly useful in instances where the load is heavy and bulky. For instance, the conveying roller 110 can be used to load and discharge a safe onto/from the apparatus 10, provided the conveying roller 110 and the projecting portions 113 are sized for such a load.

The endless track system 13 can be used in combination with the conveying roller 110 to convey the load onto the support surface of load-supporting surface 21. More specifically, if the rollers 61 of the roller system 60 are deployed, the apparatus 10 does not rest on the endless track 30C (FIG. 7). Therefore, a load may be tilted on both the exposed portion of the endless track 30C and the conveying roller 110, at which point an actuation of the endless track system 13 can entrain the load onto the load-supporting surface 21.

Referring to the side elevation views of the apparatus 10, such as FIGS. 4 and 5, it is seen that the front wheel 30A of the endless track system 13 is well exposed beyond the lateral side 23, as opposed to the rear wheel 30B. The exposure of the endless track system 13 at the front end thereof enables the apparatus 10 to climb obstacles, such as stairs. Oppositely, the endless track system 13 is generally concealed within the casing 20, to prevent having the rear portion of the endless track system 13 as the only point of contact with the inclined surface, in an hazardous situation where the apparatus 10 is tilted toward overturning.

The various components of the apparatus 10 are principally positioned toward a front end of the apparatus 10, such that the center of mass of the apparatus 10 is closer to a front end of the apparatus 10 than a rear end thereof. This will further reduce the possibility of an overturn of the loaded apparatus 10.

The apparatus 10 is used efficiently to carry loads on unstable ground, such as snow, sand, mud or the like. The endless track system 13 offers sufficient traction to displace the load through unstable ground.

It is within the ambit of the present invention to cover any obvious modifications of the preferred embodiment described herein, provided such modifications fall within the scope of the appended claims.

1. An apparatus for carrying loads on inclined surfaces, comprising:
a support surface adapted to fixedly support a load;
an endless track connected to the support surface and adapted to propel the apparatus on an inclined surface;
a power source for actuating the endless track; and
an anti-roll device for increasing a length of the apparatus beyond the endless track in a direction of movement of the apparatus on the inclined surface to prevent an overturning of the apparatus when transporting loads.

2. The apparatus according to claim 1, wherein the anti-roll device is at least one arm projecting rearwardly from the apparatus in a projecting position thereof.

3. The apparatus according to claim 2, wherein the at least one arm is displaceable from a retracted position, wherein the at least one arm is retracted so as not to project from a rear end of the apparatus, and the projecting position.

4. The apparatus according to claim 3, wherein an actuation of a displacement of the at least one arm from the retracted position to the projecting position is automated as a function of an inclination of the apparatus.

5. The apparatus according to claim 1, further comprising a brake for blocking the endless track so as to prevent an unwanted displacement of the apparatus on an inclined surface.

6. The apparatus according to claim 1, further comprising a roller system with rollers selectively deployable for displacing the apparatus without the endless track on given surfaces.

7. The apparatus according to claim 6, wherein the roller system has an actuated mechanism connected to the power source for deploying the rollers.

8. The apparatus according to claim 6, wherein the roller system has four rollers, with one roller positioned adjacent to each corner of the apparatus.

9. The apparatus according to claim 8, wherein the rollers each have a swivel mechanism.

10. The apparatus according to claim 1, wherein the support surface is pivotally displaceable with respect to a remainder of the apparatus so as to be selectively oriented for carrying a load on an inclined surface.

11. The apparatus according to claim 1, wherein the support surface is displaceable with respect to a height dimension of the apparatus, for facilitating the reception and discharge of a load thereon from or onto an elevated surface.

12. The apparatus according to claim 1, further comprising a cylindrical roller mounted to the apparatus adjacent to the support surface, for facilitating the positioning of a load onto the support surface.

13. An apparatus for carrying loads on inclined surfaces, comprising:
a support surface adapted to fixedly support a load;
an endless track connected to the support surface and adapted to propel the apparatus on an inclined surface;
a power source for actuating the endless track; and
a cylindrical roller mounted to the apparatus adjacent to the support surface, for facilitating the positioning of a load onto the support surface.

14. The apparatus according to claim 13, further comprising a brake for blocking the endless track so as to prevent an unwanted displacement of the apparatus on an inclined surface.

15. The apparatus according to claim 13, further comprising a roller system with rollers selectively deployable for displacing the apparatus without the endless track on given surfaces.

16. The apparatus according to claim 15, wherein the a portion of the endless track is exposed beyond the support surface and adjacent to the cylindrical roller, whereby a load is conveyed by a drive of the endless track with a conveying of the cylindrical roller when the rollers are deployed.

17. The apparatus according to claim 15, wherein the roller system has four rollers, with one roller positioned adjacent to each corner of the apparatus.

18. The apparatus according to claim 17, wherein the rollers each have a swivel mechanism.

19. The apparatus according to claim 13, wherein the support surface is pivotally displaceable with respect to a remainder of the apparatus so as to be selectively oriented for carrying a load on an inclined surface.

20. The apparatus according to claim 13, wherein the support surface is displaceable with respect to a height dimension of the apparatus, for facilitating the reception and discharge of a load thereon from or onto an elevated surface.
